(19) United States
(12) Patent Application Publication
(10) Pub. No.: US 2018/0363706 A1
(43) Pub. Date: Dec. 20, 2018

(54) BALL BEARING CAGE

(71) Applicant: SCHAEFFLER TECHNOLOGIES AG & CO. KG, Herzogenaurach (DE)

(72) Inventors: Joerg NEUKIRCHNER, Euerbach (DE); Tobias HOCK, Schweinfurt (DE); Michael PAUSCH, Dittelbrunn (DE); Marco HORNUNG, Muennerstadt (DE)

(73) Assignee: SCHAEFFLER TECHNOLOGIES AG & CO. KG, Herzogenaurach (DE)

(21) Appl. No.: 16/060,699

(22) PCT Filed: Nov. 18, 2016
(86) PCT No.: PCT/DE2016/200523

§ 371 Date: Jun. 8, 2018

(30) Foreign Application Priority Data
Dec. 10, 2015 (DE) 10 2015 224 859.3

(51) Int. Cl. F16C 33/38; F16C 33/66; F16C 33/46; F16C 19/06

(52) U.S. Cl. CPC F16C 33/3887; F16C 33/3856; F16C 2300/22; F16C 33/4676; F16C 19/06; F16C 33/6614

(57) ABSTRACT

A ball bearing cage, comprising a plurality of rolling body pockets each formed by portions of encircling side rings and webs connecting the side rings, wherein the rolling body pockets are configured to guide a respective rolling body with play in a circumferential direction, wherein the rolling body pockets include lateral guide contours that are parallel to the side rings and further include inwardly protruding corner projections configured to make contact with the rolling body.

### CROSS-REFERENCE TO RELATED APPLICATIONS

This application is the U.S. National Phase of PCT/DE2016/200523 filed Nov. 18, 2016, which claims priority to DE 102015224859.3 filed Dec. 10, 2015, the entire disclosures of which are incorporated by reference herein.

### TECHNICAL FIELD

The disclosure relates to a ball bearing cage, suitable in particular for use in a spindle bearing, according to the disclosure below.

### BACKGROUND

A ball bearing cage of this type is known for example from EP 2 787 229 A1. This ball bearing cage has both circular as well as elongated roller element pockets, extending along the circumference of the bearing cage.

Other ball bearing cages with roller element pockets that are not circular are known, for example from DE 10 2010 047 962 A1, US pat. no. 2007/0116395 A1, and WO 2010/066293 A1.

### SUMMARY

One object of the disclosure is to further develop, with respect to the prior art, a ball bearing cage with roller element pockets that enable a guidance of the roller elements, i.e. balls, with play in the circumferential direction of the ball bearing, wherein operation of the ball bearing should be possible even at the high rotational rates present in spindle bearings in machine tools.

One of the objects is achieved according to the disclosure by a ball bearing cage that has the features described below. The ball bearing cage is designed as a window cage, wherein all of the roller bearing pockets, i.e. the windows in the ball bearing cage, are identically shaped.

In a basic design known per se, the ball bearing cage has two circumferential lateral rings, which may be connected to one another by webs in an integral manner. The individual roller element pockets are each delimited by sections of the lateral rings and by two adjacent webs along the circumference. Lateral guide contours in each of the roller element pockets are parallel to one another and to the lateral rings. Unlike the lateral guide contours, the boundaries of the roller element pockets formed by the webs are referred to as edge sections. In contrast to the lateral guide contours, the edge sections do not need to be provided such that a roller element, i.e. a ball, runs along them. Instead, a total of four corner projections extend at the transitions between the lateral guide contours and the webs into the roller element pockets, which are in contact with the roller elements located in the roller element pockets. The roller element is thus guided with play in the circumferential direction of the ball bearing by the lateral guide contours, wherein the contact areas between the roller elements and the ball bearing cage, which are relevant regarding cage friction when the roller elements roll along the boundaries of the roller element pockets in the circumferential direction, are minimized by the corner projections.

The complex geometry of the roller element pockets with straight lateral guide contours and corner projections extending into the roller element pockets also proves a lubricant reservoir, such that lubricant, in particular grease, can readily enter the contact area between the roller element and the ball bearing cage. As a result of the low friction, the ball bearing cage is also suitable for use at high rotational rates, wherein in contrast to conventional bearing structures, the bearing can still be used with extreme loads without external cooling of the bearing.

The corner projections extending inward in each roller element pocket are each rounded off in an advantageous design, the radius of which corresponds to at least a transition radius between the corner projection and the lateral guide contour formed by a lateral ring. The rounding of the corner projection forms a curve in the opposite direction of the curve formed in the transition area between the corner projection and the lateral guide contour. As a result, there are thus alternating concave and convex contours formed on the edges of the roller element pockets.

The edge sections between two corner projections, oriented substantially parallel to the ball bearing axis, preferably form straight boundaries of the roller element pockets that are perpendicular to the lateral guide contours. This is at least the case in the transition area between the edge section and the outer circumference of the web. In a view of the ball bearing cage from above, the roller element pocket thus forms a closed rectangular shape, extending radially inward toward the bearing axis, wherein this rectangle is modified by the corner projections facing the middle of the roller element pocket, thus approximating a dodecagon.

Each roller element pocket is tapered radially from the outside toward the inside in an advantageous design, at least as far as the lateral guide contours are concerned. The lateral guide contours run to the inner circumference of the ball bearing cage in the form of guide rails. The guide rails are provided for guiding a roller element radially while maintaining a circumferential play of the roller element within the roller element pocket. All of the guide rails are in a circle that is smaller than the pitch circle of the ball bearing cage. The pitch circle is understood to be the circle running through the centers of the balls in the bearing. The ball bearing cage is thus radially supported by the roller elements at the inside of the balls. The difference between the radius of the circle on which the guide rails lie and the pitch circle of the roller bearing is preferably large enough that a sufficiently stable support is obtained between the roller elements and the bearing cage in the radial direction, while at the same time being small enough that the individual balls are in contact with the ball bearing cage close enough to their respective axes of rotation, such that the relative speed between the outer surface of the ball and the bearing cage, and thus also the friction between the roller elements and the bearing cage, are kept low.

The two outer end surfaces of the lateral rings may be flat, such that the ball bearing cage is cylindrical, delimited by the flat end surfaces. The radial inward tapering of the roller element pockets allows the lateral rings to become broader radially toward the interior. In contrast thereto, the thickness of the webs, measured along the circumference, may decrease radially from the outside toward the inside. While at the outer circumference of the ball bearing cage, the webs may transition smoothly into the lateral rings, i.e. the outer circumference of the lateral rings, which is identical to the outer circumference of the overall ball bearing cage, is identical to the circumference of an circle placed directly around the webs, the insides of the webs extend radially less toward the interior than the lateral rings. The webs thus form recesses on the inside of the ball bearing cage. These recesses form further volumes for receiving lubricant.

The ball bearing cage can reasonably be made of plastic, in particular fiber-reinforced plastic. The ball bearing cage can be used, for example, in a groove ball bearing, a four-point bearing, or a angular ball bearing.

### BRIEF DESCRIPTION OF THE DRAWINGS

Two embodiments of the ball bearing cage designed according to the disclosure shall be explained in greater detail with reference to the attached drawings. Therein:

FIG. 1 shows a perspective illustration of a first exemplary embodiment of a ball bearing cage,

FIG. 2 shows a detail of the ball bearing cage according to FIG. 1, with a ball guided therein,

FIG. 3 shows components of a ball bearing with the ball bearing cage according to FIG. 1 in a sectional view,

FIG. 4 shows excerpts of a top view of the ball bearing cage according to FIG. 1 in the radial direction, and

FIG. 5 shows a modified embodiment of a ball bearing cage.

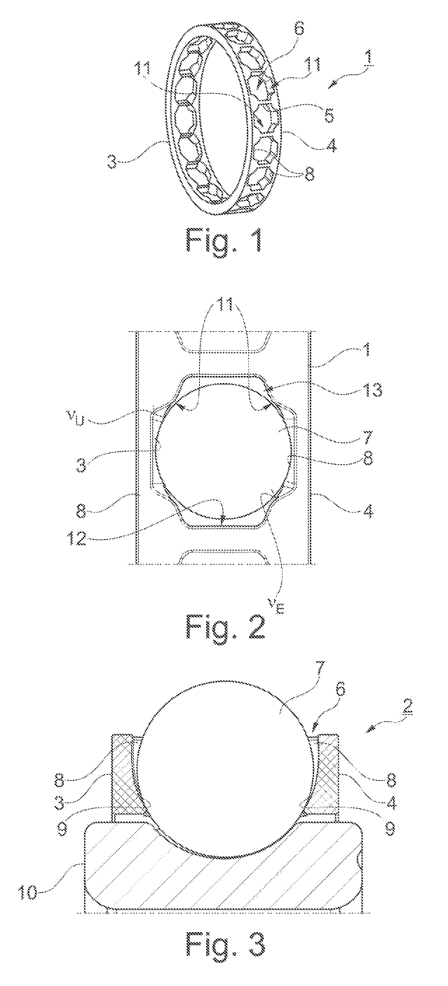

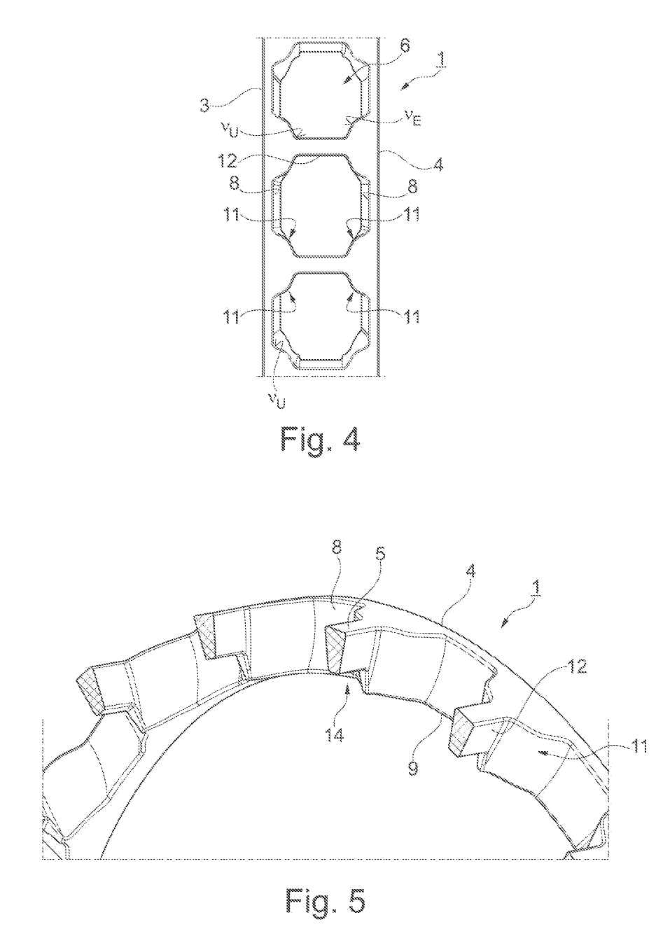

### DETAILED DESCRIPTION

The following descriptions, if not otherwise specified, relate to the two exemplary embodiments. Corresponding or identical parts in terms of their function are always indicated with the same reference symbols.

A ball bearing cage 1 is designed as a window cage made of plastic for use in a ball bearing 2. The ball bearing cage 1 is made of two lateral rings 3, 4, connected to one another by webs 5, wherein roller element pockets are formed between sections of the lateral rings 3, 4 and the webs 5, each of which is provided for guiding a roller element 7, i.e. a ball.

Guide contours 8 parallel to the end surfaces of the lateral rings 3, 4, which delimit a roller element pocket 6, expand such that the roller element 7 has play within the roller element pocket 6 along the circumference of the ball bearing cage 1. The guide contours 8 run along the inside of the lateral rings 3, 4 in the form of guide rails, under which the roller elements 8 engage. The guide rails 9 are in the proximity of the an inner ring 10 of the ball bearing 2, along which the roller elements 7 roll. The guide rails 9 formed on the inner circumference of the lateral rings 3, 4 are each circular, lying radially inside the pitch circle of the ball bearing 2. The pitch circle is that circle running through the centers of the roller elements 7.

While the guide rails 9 support the ball bearing cage 1 on the roller elements 7 radially in the ball bearing 2, corner projections 11 extending into the roller element pockets 6 ensure that each roller element 7 is guided with play by the roller element pockets 6, while preventing large surface contact along the circumference. The corner projection 11 is rounded at the region of contact between the roller element 7 and the corner projection 11, the radius of which is indicated as r_{E}. The corner projections 11 transition into the lateral rings 3, 4 with a transition radius r_{U}. The transition radius r_{U} is smaller than the rounding radius r_{E} of each corner projection 11.

In the area between two corner projections adjoining a lateral ring 3, 4, the roller element pocket 6 is delimited by an edge section 12 running axially to the ball bearing 2. A transition radius between the edge section 12 and the corner projection 11 corresponds to the transition radius r_{U} between the corner projection 11 and the lateral guide contour 8. As can be seen in particular in FIG. 2, the roller element 6 is not in contact with the edge section 12 when it rolls along the corner projection 11, such that a grease chamber 13 remains between the roller element 7 and the edge section 12.

A radial inward tapering of each roller element pocket 6 is obtained—as described—by the design of the lateral rings 3, 4, which become thicker radially inward, toward the guide rails 9. In contrast, the webs 5 become thinner, starting from the edge sections, toward the interior—measured along the circumference of the ball bearing cage 1. In this manner, a particularly large grease chamber 13 is provided. This effect is particularly pronounced in the embodiment according to FIG. 5, in which the webs 5 have recesses 14 on their inner surfaces, i.e. facing the rotational axis of the ball bearing 2. The height of the webs 5 of the ball bearing cage according to 5, measured radially, is thus less than the height of the lateral rings 3, 4 measure in the same direction.

### LIST OF REFERENCE SYMBOLS

1 ball bearing cage
2 ball bearing
3 lateral ring
4 lateral ring
5 web
6 roller element pocket
7 roller element
8 lateral guide contour
9 guide rail
10 inner ring
11 corner projection
12 edge section
13 grease chamber
14 recess
r_{E} rounding radius
r_{U} transition radius

1. A ball bearing cage comprising:
a plurality of roller element pockets, each formed by sections of circumferential lateral rings and webs connecting the lateral rings, which are designed for guiding a roller element with play in a direction of the circumference, wherein the roller element pockets include lateral guide contours that are parallel to the lateral rings, wherein the roller element pockets have corner projections at transitions from the lateral guide contours to the webs that extend inward, provided for contact with a roller element.

2. The ball bearing cage according to claim 1, wherein the inward extending corner projections are rounded, a radius of which corresponds at least to a transition radius formed between the corner projection and the lateral guide contour.

3. The ball bearing cage of claim 1, wherein an axial edge section of the roller element pocket lying between two corner projections describes a straight delimitation of the roller element pockets, orthogonal to the lateral guide contours.

4. The ball bearing cage of claim 1, wherein the roller element pockets taper radially inward.

5. The ball bearing cage of claim 1, wherein the lateral guide contours run radially inward as guide rails running circumferentially, which are provided for guiding a roller element radially while maintaining a circumferential play.

6. The ball bearing cage of claim 1, wherein a thickness of the web measured circumferentially decreases radially inward.

7. The ball bearing cage of claim 6, wherein an inner contour of the web is disposed radially further outward than the inner contours of the lateral rings.

8. The ball bearing cage of claim 1, wherein all of the roller element pockets have the same shape.

9. The ball bearing cage of claim 1, wherein it is made of plastic, in particular fiber-reinforced plastic.

10. (canceled)

11. A ball bearing cage used in a ball bearing, comprising:
a first and second lateral ring connected by a web; and
one or more roller element pockets configured to guide roller elements that have play in a circumferential direction of the ball bearing, wherein the roller element pockets include lateral guide contours parallel to the first and second later ring, and further include corner projections at transitions from the lateral guide contours to the webs that extend inward, provided for contact with a roller element.

12. The ball bearing cage of claim 11, wherein a thickness of the web measured circumferentially decreases radially inward.

13. The ball bearing cage of claim 11, wherein all of the roller element pockets have the same shape.

14. The ball bearing cage of claim 11, wherein an inner contour of the web is disposed radially further outward than the inner contour of the first and second lateral ring.

15. The ball bearing cage of claim 11, wherein the roller element pockets include a plurality of edges, wherein alternating concave and convex contours are formed on the edges.

16. The ball bearing cage of claim 11, wherein the roller element pocket is delimited by an edge section running axially to the ball bearing.

17. The ball bearing cage of claim 16, wherein a grease chamber is located between the roller element and the edge section.

18. A ball bearing cage, comprising:
a plurality of rolling body pockets each formed by portions of encircling side rings and webs connecting the side rings, wherein the rolling body pockets are configured to guide a respective rolling body with play in a circumferential direction, wherein the rolling body pockets include lateral guide contours that are parallel to the side rings and further include inwardly protruding corner projections configured to make contact with the rolling body.

19. The ball bearing cage of claim 18, wherein the rolling body pockets taper radially inward.

20. The ball bearing cage of claim 18, wherein the lateral guide contours run radially inward as rails running circumferentially and are configured to guide the rolling body radially while maintaining a circumferential play.
